(19) United States
(12) Patent Application Publication
(10) Pub. No.: US 2020/0246205 A1
(43) Pub. Date: Aug. 6, 2020

(54) WHEEL STRUCTURE

(71) Applicants: TAIWAN AN I CO., LTD., CHIA-YI SHIANN (TW); A&I INDUSTRIES LTD SHUNDE FOSHAN, FOSHAN CITY (CN)

(72) Inventor: CHUNG-FA HUANG, CHIA-YI SHIANN (TW)

(21) Appl. No.: 16/267,756

(22) Filed: Feb. 5, 2019

(51) Int. Cl. A61G 5/10; B60B 21/04; B60B 21/10; B60C 7/24; B60C 11/04; B60B 1/06

(52) U.S. Cl. CPC A61G 5/10; B60B 21/04; B60B 21/104; B60C 7/24; B60B 2200/22; B60B 1/06; B60B 2900/111; B60B 2360/10; B60C 11/04

(57) ABSTRACT

A wheel structure includes a rim and a tire. The rim includes a body, hub and spokes. The body has two edges which first and second flanges are annularly disposed at, respectively, to form a tire holder. First and second walls are annularly disposed at the edges of the body in such a manner to face the first and second flanges, respectively, allowing a first engaging slot to be formed between the first flange and the first wall and a second engaging slot to be formed between the second flange and the second wall. The tire is coupled to the tire holder. First and second coupling portions are disposed at two inner edges of the tire and coupled to the first and second engaging slots, respectively. A hollow core portion is formed between the first and second coupling portions.

### FIELD OF THE INVENTION

The present disclosure relates to wheel structures and, more particularly, to a wheel structure which is lightweight and resilient.

### BACKGROUND OF THE INVENTION

A conventional wheel for use with a wheelchair or mobility aid has a rim and a solid tire to enable the wheelchair or mobility aid to move.

However, the solid tire is not only heavy but also lacks resilience. As a result, the wheelchair or mobility aid is not comfortable.

Therefore, it is imperative to provide a wheel structure which is lightweight and resilient.

### SUMMARY OF THE INVENTION

In view of the aforesaid drawbacks of the prior art, it is an objective of the present disclosure to provide a wheel structure which is lightweight and resilient.

In order to achieve the above and other objectives, the present disclosure provides a wheel structure comprising a rim and a tire. The rim comprises a body and is concentric with a hub. A plurality of spokes is connected between the body and the hub. The body has two edges which a first flange and a second flange are annularly disposed at, respectively, to form a tire holder. A first wall and a second wall are annularly disposed at the edges of the body in such a manner to face the first flange and the second flange, respectively, allowing a first engaging slot to be formed between the first flange and the first wall and a second engaging slot to be formed between the second flange and the second wall. The tire is coupled to the tire holder of the rim. A first coupling portion and a second coupling portion are disposed at two inner edges of the tire and coupled to the first engaging slot and the second engaging slot, respectively, such that a hollow core portion is formed between the first coupling portion and the second coupling portion.

In an embodiment of the wheel structure, the rim is made of metal or non-metal.

In an embodiment of the wheel structure, the first flange and the second flange have a plurality of protruding portions protruding toward the first wall and the second wall, respectively.

In an embodiment of the wheel structure, the first wall and the second wall have a plurality of protruding portions protruding toward the first flange and the second flange, respectively.

In an embodiment of the wheel structure, a plurality of protruding portions is disposed on a bottom surface of the first engaging slot and a bottom surface of the second engaging slot.

In an embodiment of the wheel structure, an outer edge of the tire has a plurality of tread ribs.

In an embodiment of the wheel structure, an outer edge of the tire has a smooth surface.

Therefore, regarding the wheel structure of the present disclosure, the first coupling portion and the second coupling portion of the tire are coupled to the first engaging slot and the second engaging slot of the rim, respectively, and the shape of the hollow core portion is maintained because the first coupling portion and the second coupling portion of the tire are restrained and supported by the first flange, the first wall, the second flange and the second wall of the rim, respectively. Therefore, the wheel structure of the present disclosure is lightweight and resilient.

### BRIEF DESCRIPTION OF THE DRAWINGS

FIG. 1 is a perspective view of a wheel structure according to the first embodiment of the present disclosure;

FIG. 2 is an exploded view of the wheel structure according to the first embodiment of the present disclosure;

FIG. 3 is a cross-sectional view of the wheel structure according to the first embodiment of the present disclosure; and

FIG. 4 is a perspective view of the wheel structure according to the second embodiment of the present disclosure.

### DETAILED DESCRIPTION OF THE PREFERRED EMBODIMENTS

Objectives, features, and advantages of the present disclosure are hereunder illustrated with specific embodiments, depicted with drawings, and described below.

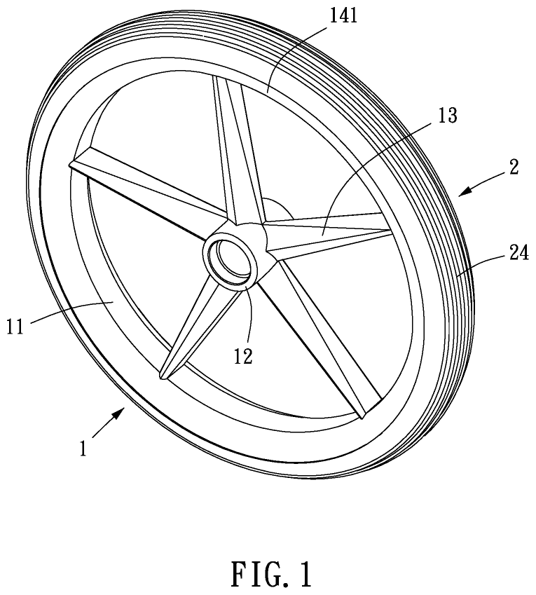

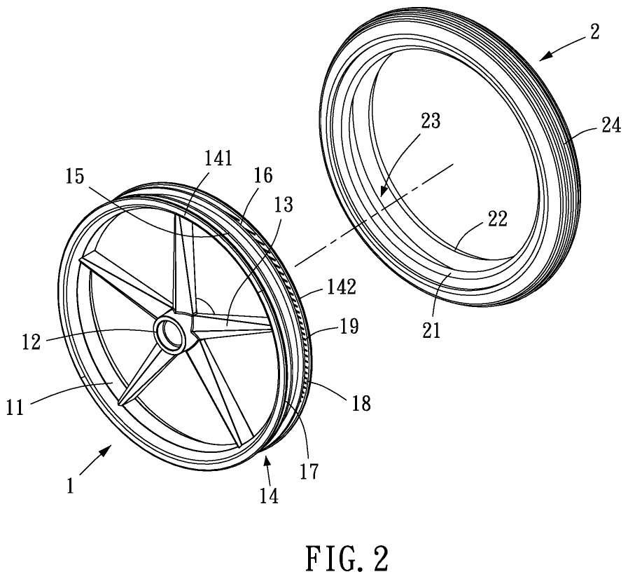

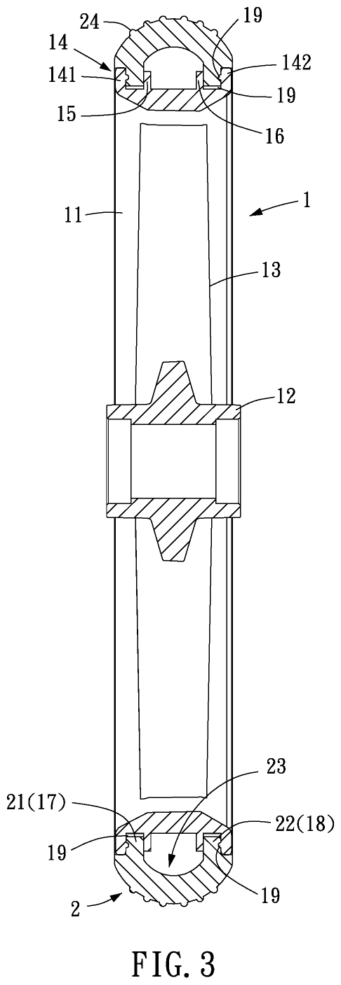

Referring to FIG. 1 through FIG. 3, the present disclosure provides a wheel structure comprising a rim 1 and a tire 2.

The rim 1 comprises a body 11. A hub 12 is disposed at the center of the wheel structure and therefore is concentric with the rim 1. A plurality of spokes 13 is connected between the body 11 and the hub 12. The body 11 has two edges which a first flange 141 and a second flange 142 are annularly disposed at, respectively, to form a tire holder 14. A first wall 15 and a second wall 16 are annularly disposed at the edges of the body 11 in such a manner to face the first flange 141 and the second flange 142, respectively. Therefore, a first engaging slot 17 is formed between the first flange 141 and the first wall 15, and a second engaging slot 18 is formed between the second flange 142 and the second wall 16.

The tire 2 is coupled to the tire holder 14 of the rim 1. A first coupling portion 21 and a second coupling portion 22 are disposed at two inner edges of the tire 2 and coupled to the first engaging slot 17 and the second engaging slot 18, respectively. A hollow core portion 23 is formed between the first coupling portion 21 and the second coupling portion 22.

During an assembly process of the wheel structure, the first coupling portion 21 and the second coupling portion 22 of the tire 2 are coupled to the first engaging slot 17 and the second engaging slot 18 of the rim 1, respectively, such that the tire 2 and the tire holder 14 are coupled together, so as to allow the first coupling portion 21 to be restrained and supported by the first flange 141 and the first wall 15 and the second coupling portion 22 to be restrained and supported by the second flange 142 and the second wall 16, thereby maintaining the predetermined shape of the hollow core portion 23.

Not shown, using the wheel structure involves fixing the hub 12 to the rotating shaft of a wheelchair or mobility aid to assist with movement. Since the first coupling portion 21 and the second coupling portion 22 of the tire 2 are restrained and supported by the first flange 141, the first wall 15, the second flange 142 and the second wall 16 of the rim 1, respectively, the predetermined shape of the hollow core portion 23 can remain unchanged. The hollow core portion 23 not only renders the tire 2 resilient when the tire 2 is in contact with the ground but also renders the tire 2 lightweight.

In a preferred embodiment of the present disclosure, the rim 1 is made of metal or non-metal. Therefore, the wheel structure meets usage requirements of various wheelchairs and mobility aids.

In a preferred embodiment of the present disclosure, the first flange 141 and the second flange 142 have a plurality of protruding portions 19 protruding toward the first wall 15 and the second wall 16, respectively. Therefore, not only are the first coupling portion 21 and the second coupling portion 22 of the tire 2 coupled to the first engaging slot 17 and the second engaging slot 18 of the rim 1, respectively, but the protruding portions 19 also come into contact with one side of the first coupling portion 21 and one side of the second coupling portion 22 to thereby interfere therewith, so as to increase the engagement between the first coupling portion 21 and the first flange 141 and increase the engagement between the second coupling portion 22 and the second flange 142, and therefore prevent the tire 2 from sliding and thereby idly rotating within the tire holder 14. Therefore, the tire 2 and the rim 1 are coupled together firmly.

The first wall 15 and the second wall 16 have a plurality of protruding portions (not shown) protruding toward the first flange 141 and the second flange 142, so as to increase the engagement between the first coupling portion 21 and the first wall 15 and increase the engagement between the second coupling portion 22 and the second wall 16, and therefore prevent the tire 2 from sliding and thereby idly rotating within the tire holder 14. Therefore, the tire 2 and the rim 1 are coupled together firmly.

In a preferred embodiment of the present disclosure, a plurality of protruding portions 19 is disposed on the bottom surface of the first engaging slot 17 and the bottom surface of the second engaging slot 18. Therefore, not only are the first coupling portion 21 and the second coupling portion 22 of the tire 2 coupled to the first engaging slot 17 and the second engaging slot 18 of the rim 1, respectively, but the protruding portions 19 also come into contact with one side of the first coupling portion 21 and one side of the second coupling portion 22 to thereby interfere therewith, so as to increase the engagement between the first coupling portion 21 and the first engaging slot 17 and increase the engagement between the second coupling portion 22 and the second engaging slot 18, and therefore prevent the tire 2 from sliding and thereby idly rotating within the tire holder 14. Therefore, the tire 2 and the rim 1 are coupled together firmly.

In a preferred embodiment of the present disclosure, an outer edge of the tire 2 has a plurality of tread ribs 24. Therefore, the friction between the tire 2 and the ground which the tire 2 is in contact with increases to prevent the wheelchair or mobility aid in operation from skidding and thereby enhance user safety.

Furthermore, an outer edge of the tire 2 has a smooth surface (not shown). Therefore, the tire 2 can meet usage requirements in various environments.

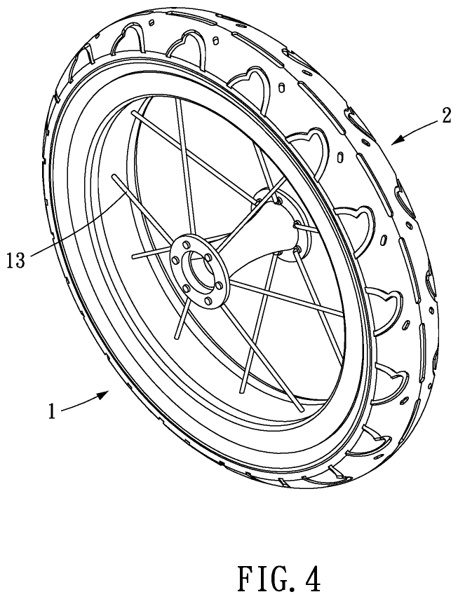

Referring to FIG. 4, the second embodiment differs from the first embodiment. In the first embodiment, the rim 1 is made of non-metal, and the spokes 13 are thicker. In the second embodiment, the rim 1 is made of metal, and the spokes 13 are rods. Therefore, the wheel structure in both the first and second embodiments meets usage requirements of various wheelchairs and mobility aids.

The present disclosure is disclosed above by preferred embodiments. However, persons skilled in the art should understand that the preferred embodiments are illustrative of the present disclosure only, but shall not be interpreted as restrictive of the scope of the present disclosure. Hence, all equivalent modifications and replacements made to the aforesaid embodiments shall fall within the scope of the present disclosure. Accordingly, the legal protection for the present disclosure shall be defined by the appended claims.

What is claimed is:

1. A wheel structure, comprising:
a rim comprising a body and being concentric with a hub, with a plurality of spokes connected between the body and the hub, the body having two edges which a first flange and a second flange are annularly disposed at, respectively, to form a tire holder, wherein a first wall and a second wall are annularly disposed at the edges of the body in such a manner to face the first flange and the second flange, respectively, allowing a first engaging slot to be formed between the first flange and the first wall and a second engaging slot to be formed between the second flange and the second wall; and
a tire coupled to the tire holder of the rim, wherein a first coupling portion and a second coupling portion are disposed at two inner edges of the tire and coupled to the first engaging slot and the second engaging slot, respectively, such that a hollow core portion is formed between the first coupling portion and the second coupling portion.

2. The wheel structure of claim 1, wherein the rim is made of metal or non-metal.

3. The wheel structure of claim 1, wherein the first flange and the second flange have a plurality of protruding portions protruding toward the first wall and the second wall, respectively.

4. The wheel structure of claim 1, wherein the first wall and the second wall have a plurality of protruding portions protruding toward the first flange and the second flange, respectively.

5. The wheel structure of claim 1, wherein a plurality of protruding portions is disposed on a bottom surface of the first engaging slot and a bottom surface of the second engaging slot.

6. The wheel structure of claim 1, wherein an outer edge of the tire has a plurality of tread ribs.

7. The wheel structure of claim 1, wherein an outer edge of the tire has a smooth surface.
